(19) United States
(12) Patent Application Publication
(10) Pub. No.: US 2020/0078929 A1
(43) Pub. Date: Mar. 12, 2020

(54) Stackable Toolbox

(71) Applicant: Ersson Co., Ltd., Taichung City (TW)

(72) Inventor: Ming-Hsien Liu, Taichung City (TW)

(21) Appl. No.: 16/123,864

(22) Filed: Sep. 6, 2018

(51) Int. Cl. B25H 3/02; B65D 21/02

(52) U.S. Cl. CPC B25H 3/021; B65D 21/0222

(57) ABSTRACT

A stackable toolbox has a body and an engaging block rotatably mounted on the body. The body has corresponding engaging grooves of two first recesses and engaging ribs of two first protrusions in positions away from the engaging block. When two toolboxes are stacked up with each other, the engaging ribs of the first protrusions of one of the toolboxes are mounted in and engaged with the engaging grooves of the first recesses of the other toolbox, and the engaging block is turned to engage with the engaging bumps of the toolboxes. Multiple stackable toolboxes may be stacked and be lifted together.

### BACKGROUND OF THE INVENTION

### 1. Field of the Invention

The present invention relates to a toolbox, and more particularly to a toolbox that can be stacked up with other toolboxes.

### 2. Description of Related Art

A conventional stackable toolbox, as disclosed in Taiwan Utility Model No. M428033, has multiple protrusions formed on a first body, and multiple recesses formed in a second body and corresponding to the protrusions of the first body in position and shape. When multiple toolboxes are stacked up, the protrusions of the first body of one toolbox are set in the recesses on the second body of another toolbox to stack up the toolboxes stably. However, after stacked, the stacked conventional toolboxes cannot be lifted together.

Another conventional stackable toolbox assembly, as disclosed in Taiwan Utility Model No. M427245, has two bodies, and each body of the toolbox assembly has a fixed sheet mounted on the body and a gap formed between the fixed sheet and the body. When two bodies are assembled, the upper body is slid to insert the fixed sheet of each body into the gap of the other body, and to engage the bodies with each other. However, because the fixed sheets are fixed on the bodies with bolts, the fixed sheets may be broken easily or the bolts may be loosened easily when heavy toolboxes engaged with each other are lifted together.

Another conventional stackable toolbox, as disclosed in Taiwan Utility Model No. M500665, has a body and two connecting elements pivotally connected to the body. When two toolboxes are stacked up with each other, the connecting elements of the upper toolbox are rotated 180 degrees relative to the body of the upper toolbox to engage with corresponding holding recesses of the body of the lower toolbox, and the toolboxes can be stacked and held stably with each other. However, the conventional stackable toolbox has the following disadvantages. The pivotal connection between each connecting element and the body would be destroyed easily by bumping impact or plucking. The engagement between connecting elements of one toolbox and the holding recesses of the other toolbox would be destroyed easily by impact. Because the connecting elements are pressed to engage with the other toolbox or are pulled to separate from the other toolbox, the connecting elements might be broken after a long-term use, and this causes failure of the engagement function of the toolbox.

To overcome the shortcomings, the present invention provides a stackable toolbox to mitigate or obviate the aforementioned problems.

### SUMMARY OF THE INVENTION

The main objective of the present invention is to provide a toolbox that has simple connection structures, can be stacked up with other toolboxes stably, and can be lifted with other toolboxes.

The stackable toolbox of the present invention has a body and an engaging block. The body has a first face, a second face, multiple side faces, two first recesses, two second recesses, two first protrusions, two second protrusions, and two engaging bumps. The first face and the second face are on opposite sides of the body. The multiple side faces are connected with the first face and the second face, and one of the multiple side faces is defined as a first side face. The two first recesses are formed in opposite side edges of the first face of the body in positions away from the first side face of the body, and each first recess has a bottom wall, multiple sidewalls, and an engaging groove formed with the bottom wall of the first recess and one of the sidewalls of the first recess away from the first side face of the body, and the engaging groove has a triangular cross section having an acute angle. The two second recesses are formed in opposite side edges of the first face of the body in positions near the first side face of the body. The two first protrusions correspond to the two first recesses of the body in position and shape, are formed on and protrude from opposite sides of the second face of the body in positions away from the first side face of the body, and each first protrusion has a top wall, multiple sidewalls, and an engaging rib corresponding to the engaging groove of the corresponding one of the first recesses. The engaging rib is formed on one of the sidewalls of the first protrusion away from the first side face of the body and has a triangular cross section having an acute angle. The two second protrusions correspond to the two second recesses of the body in position and shape, and are formed on and protrude from opposite side edges of the second face of the body in positions near the first side face of the body. The two engaging bumps are formed on and protrude from the first side face at an interval along a direction from the first face of the body to the second face of the body, and each engaging bump has a convex surface formed on a side away from the other engaging bump. The engaging block is rotatably mounted on the first side face of the body, and has a connection portion and two engaging recesses. The connection portion is formed on a middle of the engaging block and is rotatably connected with the first side face of the body at a side of one of the engaging bumps of the body away from the other engaging bump of the body. The two engaging recesses are formed in a side of the engaging block facing the first side face of the body and are located at opposite sides of the connection portion of the engaging block, and each engaging recess has a concave surface away from the other engaging recess.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a stackable toolbox in accordance with the present invention;

FIG. 2 is another perspective view of the stackable toolbox in FIG. 1;

FIG. 3 is a top view in partial section of the stackable toolbox in FIG. 1;

FIG. 3A is an enlarged cross sectional side view of the stackable toolbox in FIG. 3, showing the slot of the body.

FIG. 4 is a front view in partial section of the stackable toolbox in FIG. 1;

FIG. 4A is an enlarged cross sectional front view of the stackable toolbox in FIG. 4 showing the engaging block;

FIG. 5 is an operational side view in partial section of two toolboxes in FIG. 1 showing the toolboxes being stacked up;

FIG. 6 is a side view in partial section of the toolboxes in FIG. 5 showing the toolboxes assembled with each other;

FIG. 7 is an operational side view of the assembled toolboxes in FIG. 6;

FIG. 8 is an enlarged side view in partial section of the assembled toolboxes in FIG. 7; and

FIG. 9 is a perspective view of the assembled toolboxes in FIG. 7.

### DETAILED DESCRIPTION OF THE PREFERRED EMBODIMENT

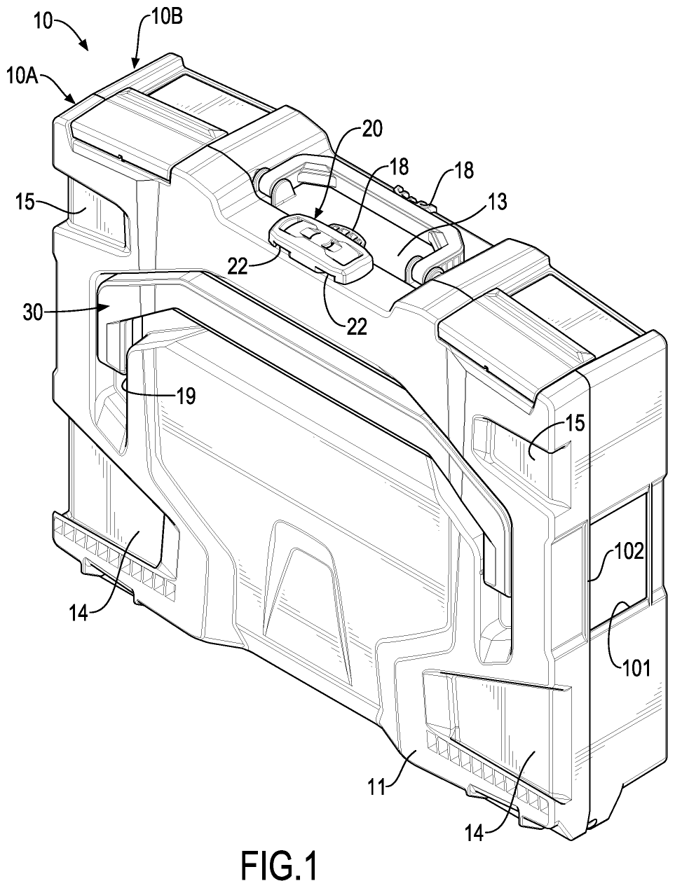

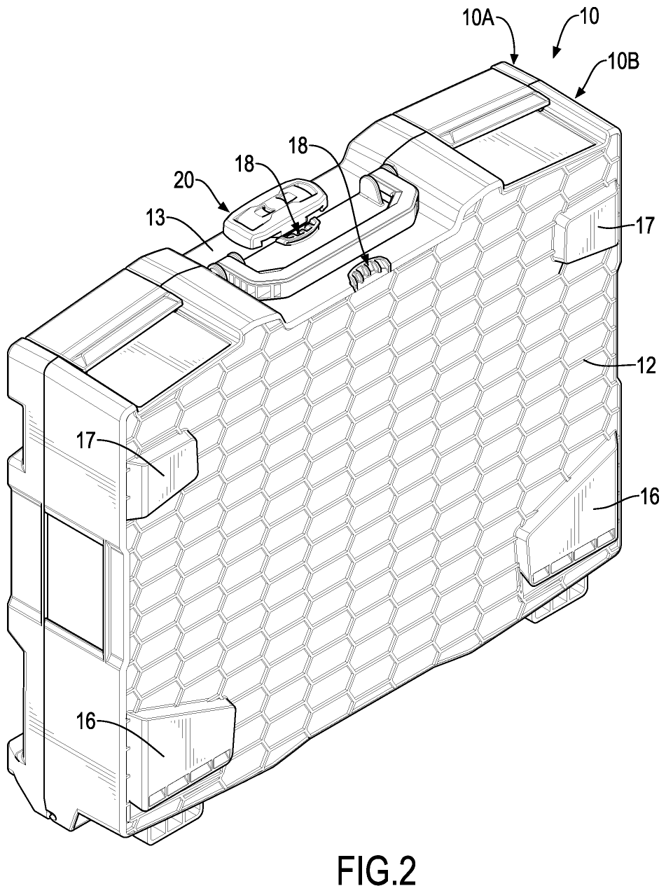

With reference to FIGS. 1 and 2, a stackable toolbox in accordance with the present invention comprises a body 10 and an engaging block 20.

The body 10 is a rectangular case, and has a first face 11, a second face 12, multiple side faces, two first recesses 14, two second recesses 15, two first protrusions 16, two second protrusions 17, and two engaging bumps 18.

The first face 11 and the second face 12 are on opposite sides of the body 10. Each side face is connected with the first face 11 and the second face 12, and one of the side faces is defined as a first side face 13. Preferably, the body 10 has two casings 10A, 10B. The two casings 10A, 10B are pivotally connected with each other at a side opposite the first side face 13 of the body 10. The first face 11 and the second face 12 are respectively formed on the two casings 10A, 10B. The side faces are formed with the two casings 10A, 10B. The body 10 has buckles mounted in a position opposite the pivotal connection of the two casings 10A, 10B for engaging the two casings 10A, 10B with each other.

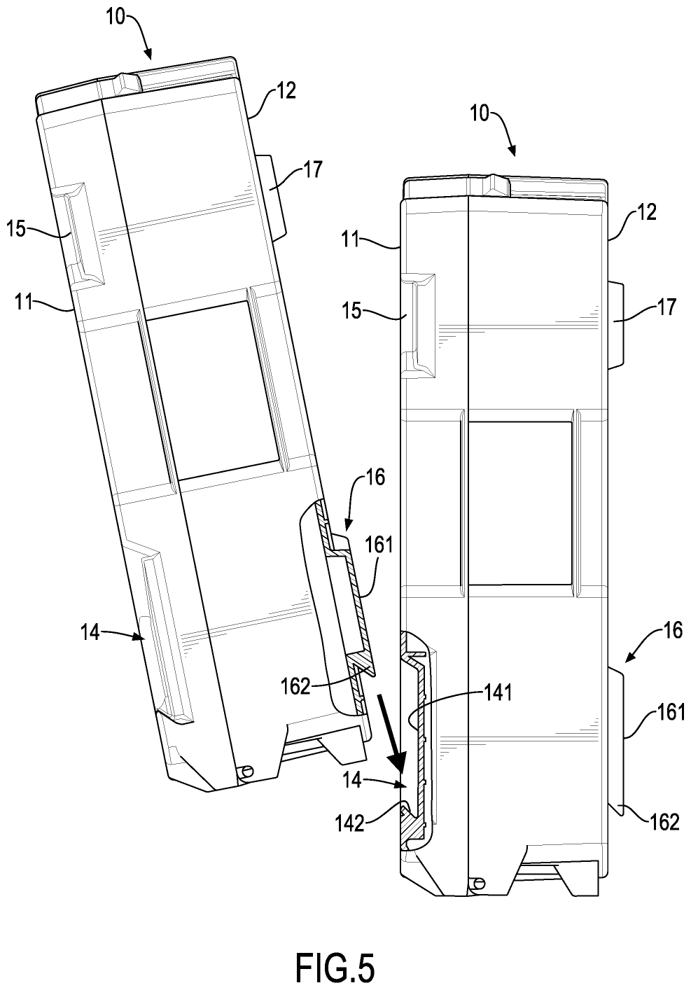

With reference to FIGS. 1 and 5, the two first recesses 14 are formed in opposite side edges of the first face 11 in positions away from the first side face 13. Each first recesses 14 has a bottom wall 141, multiple sidewalls, and an engaging groove 142 formed in one of the side walls of the first recess 14 away from the first side face 13 of the body 10. A cross section of the engaging groove 142 of each first recess 14 is triangular and has an acute angle. The two second recesses 15 are formed in opposite side edges of the first face 11 in positions near the first side face 13.

With reference to FIGS. 2 and 5, the two first protrusions 16 correspond to the two first recesses 14 of the body 10 in position and shape, and are formed on and protrude from opposite sides of the second face 12 in positions away from the first side face 13. Each first protrusion 16 has a top wall 161, multiple sidewalls, and an engaging rib 162 formed on one of the sidewalls of the first protrusion 16 away from the first side face 13. The engaging rib 162 of each first protrusion 16 has a triangular cross section having an acute angle, and corresponds to the engaging groove 142 of the corresponding one of the first recesses 14 in position and shape. The two second protrusions 17 correspond to the two second recesses 15 of the body 10 in position and shape, and are formed on and protrude from opposite side edges of the second face 12 in positions near the first side face 13.

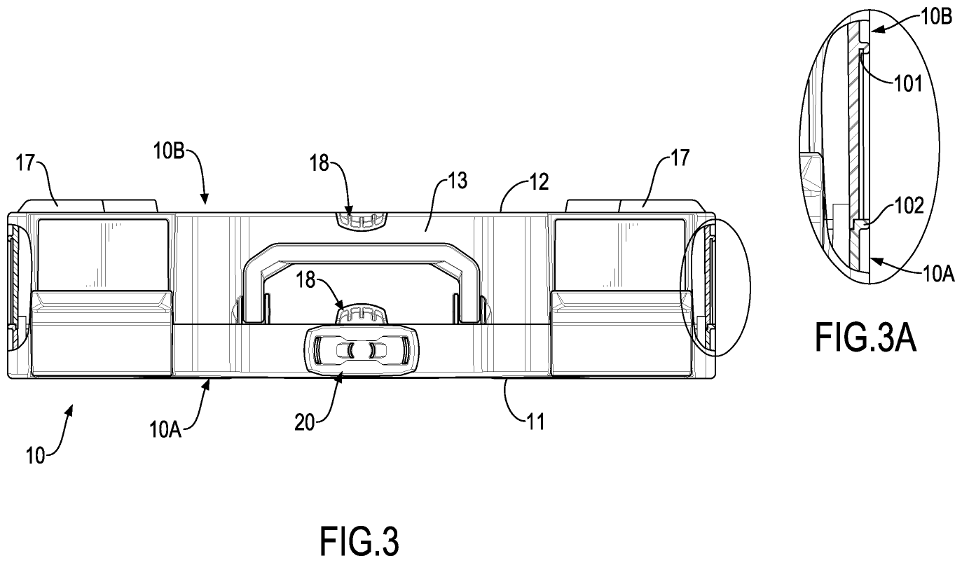

With reference to FIGS. 2 and 3, the two engaging bumps 18 are formed on and protrude from the first side face 13 at an interval along a direction from the first face 11 to the second face 12, and each engaging bump 18 has a convex surface formed on a side away from the other engaging bump 18.

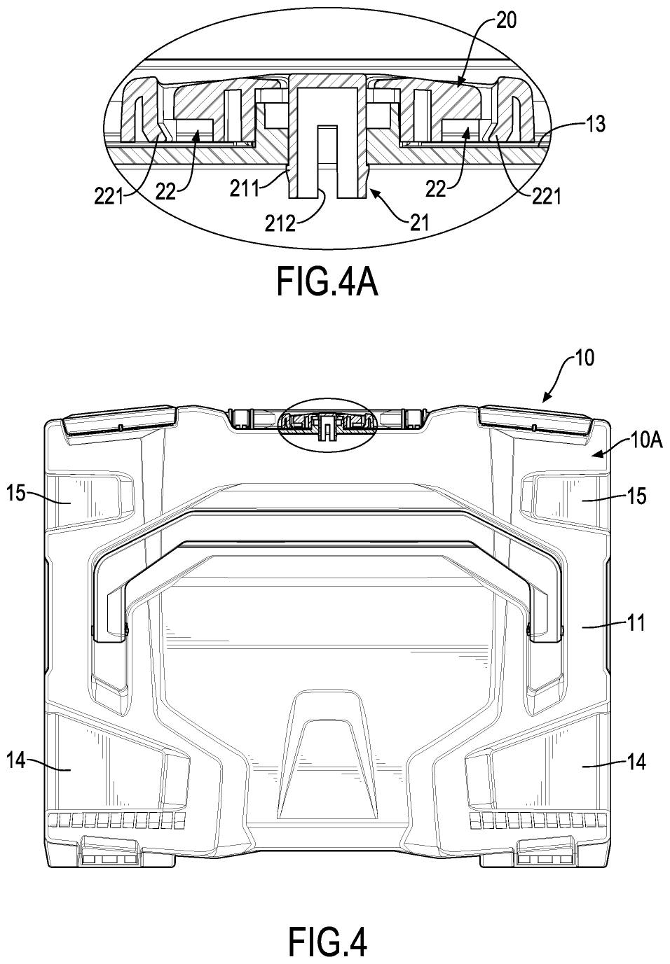

With reference to FIGS. 1, 3 and 4, the engaging block 20 is rotatably mounted on the first side face 13 of the body 10, and has a connection portion 21 and two engaging recesses 22. The connection portion 21 is formed on a middle of the engaging block 20, and is rotatably connected to the first side face 13 of the body 10 at a side of one of the engaging bumps 18 away from the other engaging bump 18. In this embodiment, the body 10 has a round hole defined through the first side face 13. The connection portion 21 of the engaging block 20 is a cylinder and is formed on and protrudes from a side of the engaging block 20 facing the first side face 13 of the body 10. The connection portion 21 has an engaging flange 211 protruding radially from the connection portion 21 to engage with the body 10, and multiple slits 212 are defined longitudinally in the connection portion 21. The slits 212 provide elasticity for the connection portion 21 to be assembled with the body 10 easily. The connection portion 21 of the engaging block 20 may be rotatably connected to the body 10 by a recess and a rib corresponding to each other, a shaft, and so on.

The two engaging recesses 22 are formed in the side of the engaging block 20 facing the first side face 13 of the body 10, and are located at opposite sides of the connection portion 21 of the engaging block 20. Each engaging recess 22 has a concave surface away from the other engaging recess 22 and corresponding to the convex surface of each engaging bump 18 of the body 10 in shape. The distance from the concave surface of each engaging recess 22 to the axis of the connection portion 21 is substantially equal to the distance from the convex surface of one of the engaging bumps 18 of the body 10 near the engaging block 20 to the axis of the connection portion 21. The engaging block 20 has an initial position and a connection position. When the engaging block 20 is in the connection position, one of the engaging recesses 22 of the engaging block 20 is engaged with one of the engaging bumps 18 of the body 10 near the engaging block 20. Preferably, the engaging block 20 has a long length and a short length; when the engaging block 20 is in the initial position, the engaging block 20 is kept from extending out from the first face 11 or the second face 12 of the body 10. The two engaging bumps 18 are formed on one of the casings 10B, and the engaging block 20 is rotatably mounted on the other casing 10A. When the engaging block 20 is in the connection position, the two casings 10A, 10B can be connected with each other by the engaging block 20.

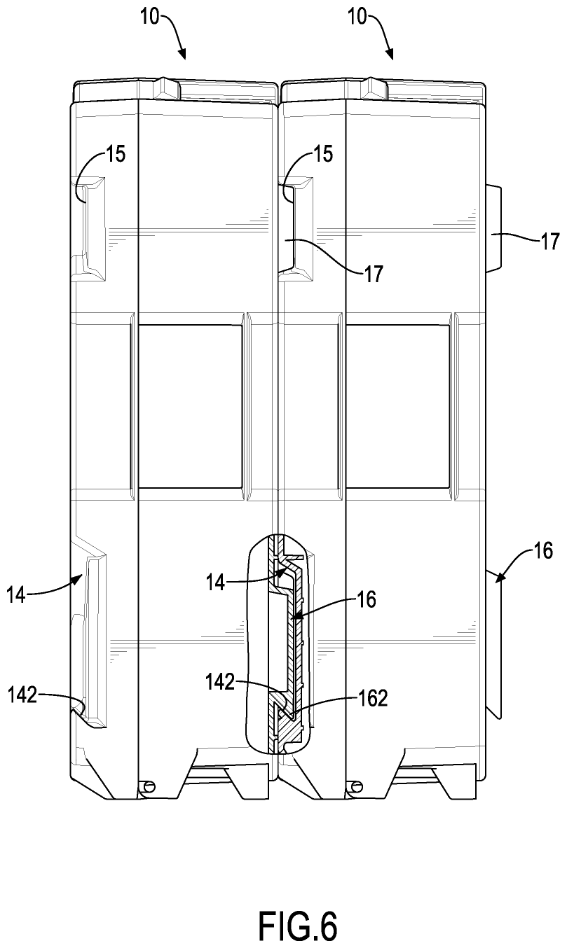

With reference to FIGS. 5 and 6, to stack up two toolboxes in accordance with the present invention with each other, the first protrusions 16 of one of the toolboxes are inserted in the first recesses 14 of the other toolbox, and the two toolboxes may be stacked up with each other and are held in a fixed position by the engagements of the engaging ribs 162 of the first protrusions 16 and the engaging grooves 142 of the first recesses 14, wherein the first protrusions 16 and the second protrusions 17 of one of the toolboxes are mounted in the first recesses 14 and the second recesses 15 of the other toolbox.

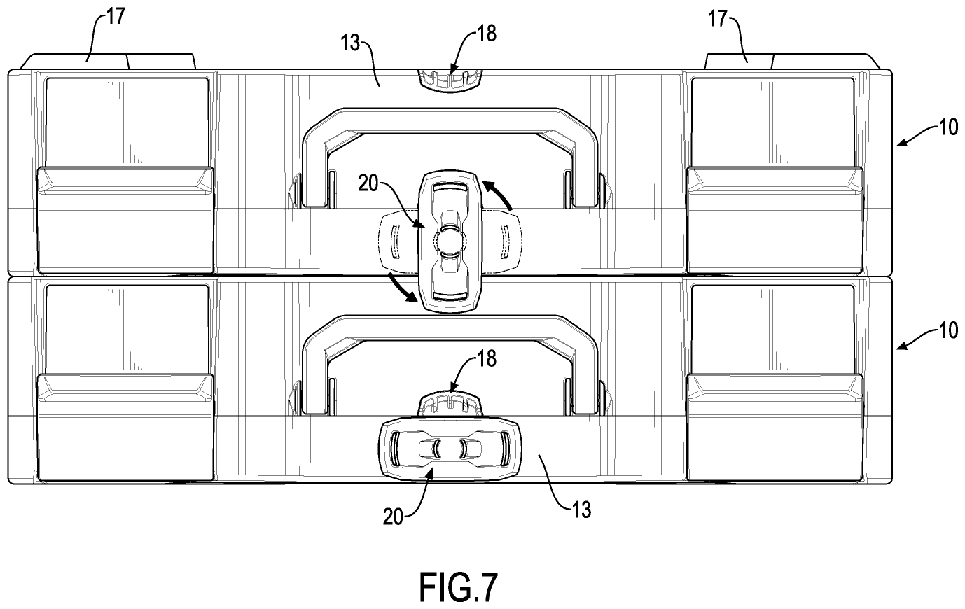

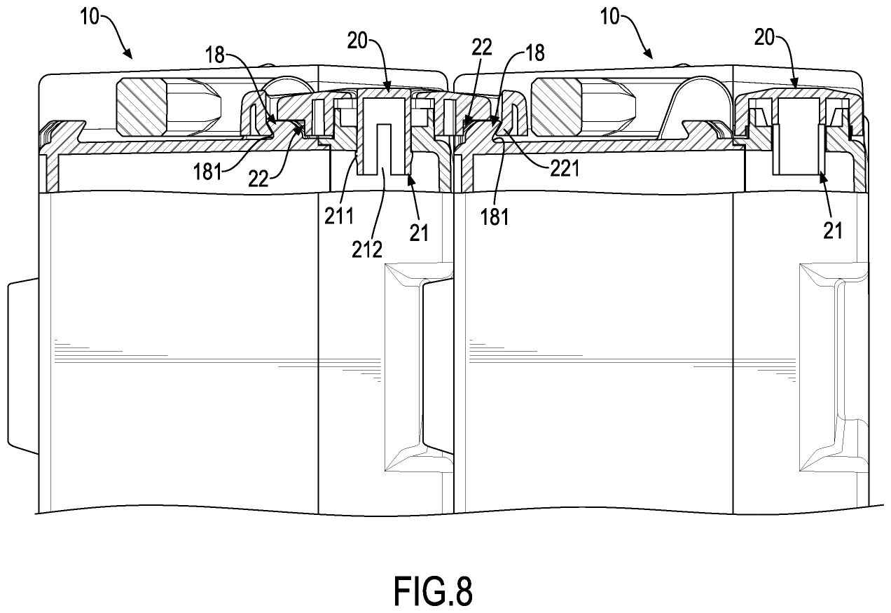

With reference to FIGS. 7 and 8, the engaging block 20 near the connected faces of the bodies 10 of the two toolboxes is turned to the connection position to connect the bodies 10, wherein each engaging recess 22 of the engaging block 20 is respectively engaged with one of the engaging bumps 18 of each body 10 near the engaging block 20. Preferably, each engaging bump 18 of each body 10 has a groove 181 formed in the convex surface of the engaging bump 18, and each engaging recess 22 of each engaging block 20 has a rib 221 formed on and protruding from the concave surface of the engaging recess 22 and corresponding to the groove 181 of each engaging bump 18 of each body 10 in shape. The engagement between the groove 181 of the engaging bump 18 and the rib 221 of each engaging recess 22 of the engaging block 20 can improve the engagement between the engaging block 20 and the engaging bump 18 when the engaging block 20 is in the connection position.

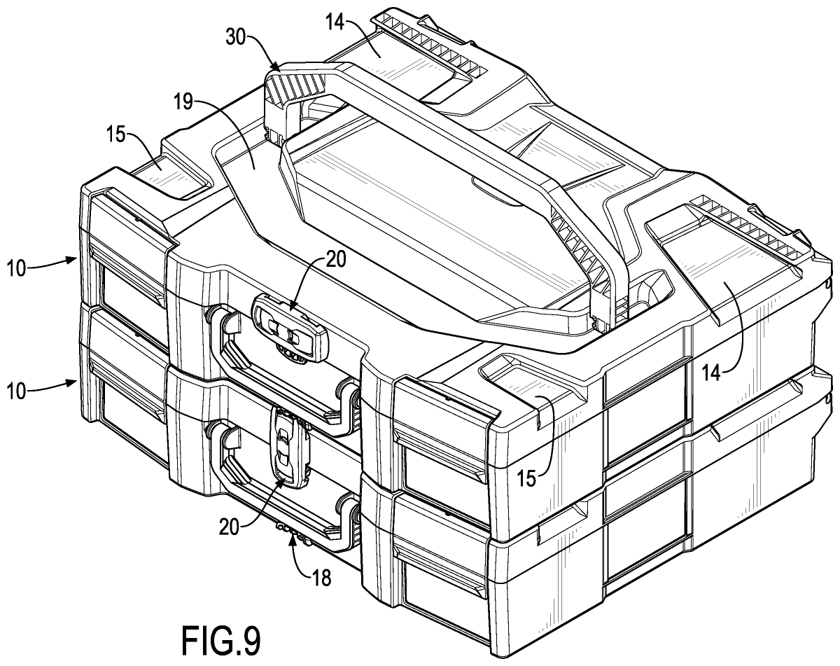

With reference to FIGS. 1 and 9, the body 10 further has a handle recess 19 formed in a middle of the first face 11 or the second face 12 of the body 10, and a handle 30 is pivotally mounted in the handle recess 19 of the body 10. When two toolboxes are connected, the bodies 10 of the toolboxes may be lifted together by the handle 30.

With reference to FIGS. 1 and 3, the body 10 further has a U-shaped slot 101 formed in the side wall of one of the casings 10B, the slot 101 has an opening facing the other casing 10A, and the other casing 10A has a protruding stop 102 corresponding to the opening of the slot 101 in position. When the body 10 is opened, a name card might be inserted in the slot 101.

According to the above-mentioned features and structural relationships of the toolbox in accordance with the present invention, the toolbox has the following advantages.

1. The structure of the toolbox in accordance with the present invention is simple and can be manufactured and assembled easily.

2. Multiple toolboxes in accordance with the present invention can be stacked up with together stably and can be lifted together with the stackable features of the present invention.

3. Two toolboxes in accordance with the present invention can be connected stably and easily.

4. The engaging block 20 may be rotatably connected to the body 10 stably and firmly by a pair of corresponding shaft and shaft hole of larger diameters, and the engaging block 20 will not be broken easily and has durable engagement between the engaging recesses 22 and the engaging bumps 18 of the two bodies 10 assembled.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stackable toolbox comprising:
a body having
a first face;
a second face being opposite the first face of the body;
multiple side faces connected with the first face and the second face, and one of the multiple side faces defined as a first side face;
two first recesses formed in opposite side edges of the first face of the body in positions away from the first side face of the body, and each first recess having
a bottom wall;
multiple sidewalls; and
an engaging groove formed with the bottom wall of the first recess and one of the sidewalls of the first recess away from the first side face of the body, and a cross section of the engaging groove being triangular and having an acute angle;
two second recesses formed in opposite side edges of the first face of the body in positions near the first side face of the body;
two first protrusions corresponding to the two first recesses of the body in position and shape, formed on and protruding from opposite sides of the second face of the body in positions away from the first side face of the body, and each first protrusion having
a top wall;
multiple sidewalls; and
an engaging rib corresponding to the engaging groove of the corresponding one of the first recesses in position and shape, formed on one of the sidewalls of the first protrusion away from the first side face of the body, and a cross section of the engaging rib being triangular and having an acute angle;
two second protrusions corresponding to the two second recesses of the body in position and shape, formed on and protruding from opposite side edges of the second face of the body in positions near the first side face of the body; and
two engaging bumps formed on and protruding from the first side face at an interval along a direction from the first face of the body to the second face of the body, and each engaging bump having a convex surface formed on a side away from the other engaging bump; and
an engaging block rotatably mounted on the first side face of the body and having
a connection portion formed on a middle of the engaging block and rotatably connected with the first side face of the body at a side of one of the engaging bumps of the body away from the other engaging bump of the body;
two engaging recesses formed in a side of the engaging block facing the first side face of the body and located at opposite sides of the connection portion of the engaging block, and each engaging recess having a concave surface away from the other engaging recess and corresponding to the concave surface of each engaging bump in shape;
an initial position; and
a connection position, wherein when the engaging block is in the connection position, one of the engaging recesses of the engaging block is engaged with one of the engaging bumps of the body near the engaging block.

2. The stackable toolbox as claimed in claim 1, wherein the connection portion of the engaging block is a cylinder, formed on and protruding from the side of the engaging block facing the first side face of the body, and has an engaging flange protruding radially from the connection portion of the engaging block and a slit defined longitudinally in the connection portion of the engaging block.

3. The stackable toolbox as claimed in claim 1, wherein each engaging bump of the body has a groove formed in the convex surface of the engaging bump, and each engaging recess of the engaging block has a rib formed on and protruding from the concave surface of the engaging recess and corresponding to the groove of each engaging bump in shape.

4. The stackable toolbox as claimed in claim 2, wherein each engaging bump of the body has a groove formed in the convex surface of the engaging bump, and each engaging recess of the engaging block has a rib formed on and protruding from the concave surface of the engaging recess and corresponding to the groove of each engaging bump in shape.

5. The stackable toolbox as claimed in claim 1, wherein the body includes two casings pivotally connected with each other at sides of the casings, and the first face and the second face of the body are respectively defined in the two casings.

6. The stackable toolbox as claimed in claim 2, wherein the body includes two casings pivotally connected with each other at sides of the casings, and the first face and the second face of the body are respectively defined in the two casings.

7. The stackable toolbox as claimed in claim 5, wherein the two engaging bumps of the body are formed on one of the two casings of the body, and the engaging block is mounted on the other casing.

8. The stackable toolbox as claimed in claim 6, wherein the two engaging bumps of the body are formed on one of the two casings of the body, and the engaging block is mounted on the other casing.

9. The stackable toolbox as claimed in claim 7, wherein the first side face of the body is opposite the sides of the two casings pivotally connected with each other.

10. The stackable toolbox as claimed in claim 8, wherein the first side face of the body is opposite the sides of the two casings pivotally connected with each other.

11. The stackable toolbox as claimed in claim 9, wherein each engaging bump of the body has a groove formed in the convex surface of the engaging bump, and each engaging recess of the engaging block has a rib formed on and protruding from the concave surface of the engaging recess and corresponding to the groove of each engaging bump in shape.

12. The stackable toolbox as claimed in claim 10, wherein each engaging bump of the body has a groove formed in the convex surface of the engaging bump, and each engaging recess of the engaging block has a rib formed on and protruding from the concave surface of the engaging recess and corresponding to the groove of each engaging bump in shape.

13. The stackable toolbox as claimed in claim 11, wherein the body has a handle recess formed in one of the first face and the second face of the body, and a handle is mounted pivotally in the handle recess of the body

14. The stackable toolbox as claimed in claim 12, wherein the body has a handle recess formed in one of the first face and the second face of the body, and a handle is mounted pivotally in the handle recess of the body.
